(19) United States
(12) Patent Application Publication
(10) Pub. No.: US 2025/0367731 A1
(43) Pub. Date: Dec. 4, 2025

(54) ELECTROMAGNETIC MELT POOL SUPPORT IN DIRECT ENERGY DEPOSITION BASED ADDITIVE MANUFACTURING PROCESSES

(71) Applicant: Bundesrepublik Deutschland, vertreten durch den Bundesminister für Wirtschaft und Energie, dieser, Berlin (DE)

(72) Inventors: Ömer ÜSTÜNDAG, Berlin (DE); Nasim BAKIR, Berlin (DE); Andrey GUMENYUK, Berlin (DE); Michael RETHMEIER, Berlin (DE); Andreas PITTNER, Potsdam (DE)

(73) Assignee: Bundesrepublik Deutschland, vertreten durch den Bundesminister für Wirtschaft und Energie, dieser, Berlin (DE)

(21) Appl. No.: 18/875,270

(22) PCT Filed: Jun. 30, 2022
(86) PCT No.: PCT/EP2022/068140

§ 371 Date: Dec. 16, 2024

(51) Int. Cl. B22F 10/38; B22F 10/20; B22F 12/90; B33Y 10/00; B33Y 30/00; B33Y 50/02; H01F 13/00

(52) U.S. Cl. CPC B22F 10/38; B22F 10/20; B22F 12/90; B33Y 10/00; B33Y 30/00; B33Y 50/02; H01F 13/00

(57) ABSTRACT

An apparatus, for generating external magnetic fields for supporting a melt pool, adapted for use in direct energy deposition based additive manufacturing processes, comprising a first control means and at least one magnet, wherein the first control means is connected to the at least one magnet such that the magnet generates an oscillating magnetic field at and/or inside the melt pool such that an eddy current is induced, and wherein a resulting current is oriented to the oscillating magnetic field such that a Lorentz force acts on the melt pool.

### TECHNICAL FIELD

This disclosure relates to an apparatus for generating external oscillating magnetic fields for supporting a melt pool, adapted for use in direct energy deposition based additive manufacturing processes and to an additive manufacturing system with such an apparatus. Further, this disclosure relates to an additive manufacturing method based on direct energy deposition and to a use of a magnet and a control means in direct energy deposition based additive manufacturing processes as a melt support.

### BACKGROUND

The use of external magnetic fields to prevent gravitational dripping of a metallic melt is already known for e.g. the laser beam welding or in combination with an arc welding process. For direct energy deposition based additive manufacturing processes (hereinafter DED-processes) a magnetic melt pool support is not known.

DED-processes may be used for rapid prototyping or the manufacturing of serial components with a high complexity in their structure, for example for parts for the aerospace industry. Further, DED-processes may be used for repair or the supply of spare parts on demand. For instance, DED-processes are characterized such that a heat source is used for melting a material line-by-line, layer-by-layer. Due to the layer-by-layer deposition of material, the melt may be supported by a previous layer and/or by a build tray and therefore, constraining the freedom of design and/or manufacturing.

Typically, DED-processes may require a high amount of processing time per component compared to other manufacturing technologies. In particular, the build-up rate, i.e. the velocity of the process, may depend on a material output. A high material output may accelerate the DED-process. In turn, the quality of the component, for example the surface finish, may depend on the material output such, that applying and melting a high amount of material at the same time may result in gravitational dripping of a metallic melt so as the quality of the component decreases or even that the process fails.

### SUMMARY

Aspects and advantages of the disclosure will be set forth in part in the following description, or may be obvious from the description, or may be learned through practice of the disclosure.

The present disclosure provides an apparatus for generating external magnetic fields for supporting a melt pool, an additive manufacturing system with such an apparatus, an additive manufacturing method and a use of a magnet and a control means in on direct energy deposition based additive manufacturing processes so as to increase a material output and therefore, decreasing the time amount per component at additive manufacturing at least at the same quality.

In one example, the disclosure provides an apparatus for generating external magnetic fields for supporting a melt pool which is adapted for use in direct energy deposition based additive manufacturing processes. The apparatus comprises a first control means and at least one magnet, wherein the first control means is connected to the at least one magnet such, that the magnet generates an oscillating magnetic field at and/or inside the melt pool so as an eddy current is induced. A resulting current is oriented to the oscillating magnetic field such, that a Lorentz force acts on the melt pool.

In another example, the disclosure provides an additive manufacturing system which comprises a heat source for applying heat on a material, a material feed for supplying the material, a build tray for receiving a substrate, at least one control means for controlling and/or regulating an additive manufacturing process and an apparatus disclosed herein.

In yet another example, the disclosure provides an additive manufacturing method based on direct energy deposition which comprises arranging a heat source for generating heat and a material feed for supplying a material on a substrate and/or a build tray such that the heat source is directed to the material. Further, the method comprises arranging at least one magnet in dependence of a position of the heat source and/or of a position of the material feed and applying heat, supplied by the heat source, on the material, supplied by the material feed, such, that at least the supplied material melts so as to form a melt pool. The method further comprises controlling the magnet by a first control means such, that an oscillating magnetic field acts substantially at the same time at and/or inside the melt pool. The heat source and/or the material feed conduct a relative movement to the substrate and/or the build tray such that the material is deposited, melted and solidified line-by-line, layer-by-layer. Wherein, according to the method disclosed herein, the oscillating magnetic field is configured for inducing an eddy current and a wherein a resulting current is oriented to the oscillating magnetic field such that a Lorentz force acts on the melt pool.

In another example, the disclosure provides a use of a magnet and a first control means in a direct energy deposition based additive manufacturing process for generating an oscillating magnetic field at and/or inside a melt pool such that an eddy current is induced and a resulting current is oriented to the oscillating magnetic field such, that a Lorentz force acts on the melt pool.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF DRAWINGS

A full and enabling disclosure of the present disclosure is set forth in the specification, which makes reference to the appended figures, in which:

FIG. 1 is a side view on a schematic DED-process using a melt support according to embodiments of the present disclosure.

FIG. 2 is a top view on the schematic DED-process shown in FIG. 1.

FIG. 3 is a front view on a schematic DED-process using a melt support according to embodiments of the present disclosure.

FIG. 4 is a schematic front view on several arrangements of a magnetic pole pair according to embodiments of the present disclosure.

### DETAILED DESCRIPTION

The techniques of this disclosure generally relate to an electromagnetic melt support in DED-processes through generating Lorentz forces. An apparatus operating according to the techniques disclosed herein enables to increase a material output in a DED-process without risking gravitational dripping of a melt. The apparatus according to this disclosure generates oscillating magnetic fields which induce a current at and/or in the melt pool. A resulting current is oriented to the magnetic field such that a Lorentz force acts on the melt pool. The dripping of melt is counteracted by the Lorentz force. In some examples, at least one component of the at least one magnet is arranged rotatable, tiltable, moveable and/or retractable and extendable so as to adjust the position of the magnetic field and increase the support on the melt pool. In other examples, at least one measurement device for monitoring and/or evaluation of a state of the melt pool is provided by the disclosure so as to increase the material output depending on the state of the melt pool.

In general, this disclosure describes generating external magnetic fields for supporting a melt pool adapted for use in DED-processes. As used herein, the term “DED-processes” refers to all additive manufacturing processes which may comprise heating a material supplied by a material feed by a heat source. The material may be deposited in a deposition direction on a build tray and/or on a substrate line-by-line, layer-by-layer. The DED-process may be conducted within a building volume.

Every environment comprising all required components for conducting a DED-process is herein indicated as an additive manufacturing system. For example, a machine for manufacturing components explicitly in an additive manner may be an additive manufacturing system. In some embodiments, a machining center may conduct a DED-process so as to be indicated as an additive manufacturing system herein.

The material may be substantially metallically and may be supplied as a powder or as a wire. As used herein, “substantially metallically” may refer to a material with a metallic portion of at least 30%. In particular, the material may comprise a metallic portion of at least 50%. Preferably, the material may comprise a metallic portion of at least 70%. The powder may comprise various grain sizes. The material may be electrically conductive in solid state. The material may be electrically conductive in a melted state.

The heat source may be a focused heat source. In particular, the heat source may be a laser, an electron beam, a light beam, an arc, a plasma or a like. The heat may be applied in a direct manner and/or through torch optics as for example one or more lenses and/or mirrors. The heat source may apply heat to the material such the material melts. The heat may be directed to a focus point.

According to some embodiments, the build tray may be part of the additive manufacturing system. In some embodiments, the build tray may be fixed to a fixation means which may be part of the additive manufacturing system so as to remove a component after the DED-process mutually with the build tray and thus, accelerating the manufacturing processes. According to some embodiments, a substrate may be fixed on the build tray, for example, a turbine blade to be repaired. The material feed may deposit material on the build tray and/or on the substrate. As used herein, the term “substrate” refers to a component to be processed and/or to any intermediate state of the component to be additively build up by the DED-process.

Typically, the additive manufacturing of a component may be conducted by the build tray, the heat source and/or a material feed moving and/or rotating and/or being fixed in a cartesian x-, y-, z-coordinate system. In some examples, the “x-, y-, z-coordinate system”, may refer to a x-, y-plane with an x-axis and a y-axis parallel to the ground and a z-axis perpendicular to that plane so as in these examples a z-direction may refer to a direction substantially opposite the gravitational force. The heat source, for instance, applies heat line-for-line according to a predetermined course on the material, deposited simultaneously by the material feed on the build tray by moving in the x-, y-plane. Subsequently to a first layer according to the predetermined course is finished, the build tray may move opposite to the z-direction by one predetermined layer height. Subsequently, a second layer may be deposited, e.g. line-by-line. According to some embodiments, the build tray may not move on the z-axis. Instead, the heat source and/or the material feed may move in the z-direction by one predetermined layer height.

In some embodiments, the heat source and/or the material feed may be fixed at a position so as the build tray may move in the x-, y- and/or z-direction in order to conduct a line-by-line, layer-by-layer deposition with the heat source and/or the material feed at the fixed position. According to some embodiments, the heat-source and/or the material feed may move in the x-, y- and/or z-direction.

According to some embodiments, the build tray, the heat source and/or the material feed may be arranged rotatable so as the build tray, the heat source and/or the material feed may be tilted and/or rotated having regard to the x-, y- and/or z-axis. In embodiments, the build tray, the heat source and/or the material feed may be arranged rotatable during an additive manufacturing process.

Typically, in an additive manufacturing system the building volume may be isolated from the atmosphere and be filled with an inert gas, for example, argon. An inert gas may increase the stability of the material properties of a manufactured component and may protect the material from oxidation. In some embodiments, the building volume may be exposed to the atmosphere during the additive manufacturing. According to some embodiments, an inert gas may be deposited mutually with the material.

According to embodiments, the apparatus may be adapted for use in DED-processes. As used herein, the term “adapted for use in DED-processes” refers to an arrangement of the components of the apparatus within the oscillating magnetic field is acting substantially on a level of the melt pool. A magnetic pole pair may be arranged laterally to a line to be deposited by the material feed and/or may be arranged such that the melt pool is substantially between the magnetic pole pair. The magnetic pole pair may be arranged on a first side of the line to be deposited and/or may be arranged on the first and on the second side of the line to be deposited.

As used herein, the term “on a level of the melt pool” refers to a level which may be defined as the height of the melt pool opposite to the z-direction starting from the build tray. The height of the melt pool may refer to the height of the focus point of the heat applied by the heat source. In particular, the center of the magnetic pole pair may be arranged at substantially this level. The term “substantially”, as used before the term “on a level of the melt pool”, refers to an arrangement, wherein the level of the center of the magnetic pole pair may differ from the level of the melt pool by less than one height of the magnetic pole pair.

In embodiments of this disclosure, the apparatus may comprise a first control means and at least one magnet. The first control means may control the at least one magnet such that the oscillating magnetic field acts at and/or inside the melt pool such, that an eddy current is induced. A resulting current may be oriented to the oscillating field such, that a Lorentz force acts on the melt pool.

According to embodiments, the at least one magnet may comprise two pole shoes arranged as the magnetic pole pair opposite to each other. The magnet may comprise a coil and a magnetic core. The first control means may apply an alternating current and/or voltage to the magnet such, that the oscillating magnetic field is acting at least between the magnetic pole pair. The first control means may be a function generator and/or an amplifier. The magnetic pole pair may be oriented substantially horizontally perpendicular to the deposition direction such, that the magnetic field may be oriented substantially horizontally perpendicular to the deposition direction. In particular, the magnetic pole pair may be oriented substantially vertically perpendicular to the deposition direction such, that the magnetic field may be oriented substantially vertically perpendicular to the deposition direction.

According to embodiments, the at least one magnet may be embodied as a permanent magnet. The permanent magnet may be rotated by the first control means in order to generate the oscillating magnetic field. In embodiments, the first control means may be a motor for rotating at least a component of the magnet.

The oscillating magnetic field may comprise a frequency of 10 Hz to 10 kHz. In particular, the oscillating magnetic field may comprise a frequency from 10 Hz to 5 kHz. Preferably, the oscillating magnetic field may comprise a frequency from 100 Hz to 2 kHz. The oscillating magnetic field may comprise a magnetic flux density of 0.01 T to 1 T.

According to embodiments, eddy currents may be induced to the substrate, in particular, to the melt pool. The resulting current may be oriented to the magnetic field such that a Lorentz force acts on the melt pool. In some embodiments, the magnetic field may be oriented substantially horizontally perpendicular to the deposition direction and the resulting current may be oriented in the deposition direction such, that the Lorentz force acts substantially vertically perpendicular to the deposition direction. In embodiments according to this configuration and wherein the build plate is oriented parallel to the ground, the Lorentz force counteracts the gravitational force.

In some embodiments, the magnetic field may be oriented substantially vertically perpendicular to the deposition direction and the resulting current may be oriented in the deposition direction such, that the Lorentz force acts substantially horizontally perpendicular to the deposition direction. In embodiments according to this configuration and wherein the build plate is oriented parallel to the ground, the Lorentz force supports the melt pool laterally.

In embodiments, the magnetic field may be oriented angled to the deposition direction and the resulting current may be oriented perpendicular to the magnetic field such, that the Lorentz force acts angled to the deposition direction. The angle may be dependent of an overhang angle.

According to embodiments, the center of the magnetic pole pair may be at a level of the melt pool such, that the impact of the electromagnetic melt pool support may be maximized. In embodiments, the upper edge of the magnetic pole pair may be arranged substantially on a level of the upper edge of the deposited material. According to embodiments, the bottom edge of the magnetic pole pair may be arranged substantially on a level of the upper edge of the deposited material. The distance between the bottom edge of the magnetic pole pair and the upper edge of the deposited material may be less than 2 mm. In particular, the distance is less than 1 mm. Preferably, the distance may be substantially 0 mm. Aligning the bottom edge of the magnetic pole pair to the upper edge of the deposited material may simplify the melt pool support such as collisions of a component of the magnet to the substrate may be excluded without any further considerations.

The melt pool may be on a level substantially on which the material is deposited. Typically, the melt pool may extend partially to the previously applied layer so as to connect the layers with each other.

As described above, the additive manufacturing is typically conducted line-by-line, layer-by-layer. According to embodiments of this disclosure, a first magnetic pole shoe may be arranged on the first side of the line to be deposited and a second magnetic pole shoe may be arranged on a second side of the line to be deposited. The magnetic field may be oriented horizontally perpendicular to the deposition direction.

In some embodiments, the magnetic pole pair may be arranged on the first side of the line to be deposited. The magnetic field may be oriented vertically perpendicular to the deposition direction.

According to embodiments, at least one component of the at least one magnet may be arranged rotatable, tiltable and/or moveable. In particular, the first and/or the second magnetic pole shoe may be arranged rotatable, tiltable and/or moveable. In some embodiments, a second control means may be configured for rotating, tilting, moving and/or retracting and extending the at least one component of the at least one magnet so as to control the at least one component having regard to a specific component in order to maximize the melt pool support and/or prevent collisions with the substrate.

In embodiments, for example the strength, orientation and/or frequency of the magnetic field may be adjustable, variable, regulable and/or controllable during an additive manufacturing process so as to optimize the melt pool support according to a present process step.

In particular preferred embodiments, the melt pool may be monitored by at least one measuring device. In particular, a state of the melt pool may continuously be monitored and/or evaluated. A contactless temperature sensor may be used for monitoring the current temperature of the melt pool, for example via optical pyrometry, IR thermography or an emission measurement using an optical camera system. According to embodiments, the measuring device may measure a length of the melt pool. In particular, the measuring device may be embodied as a laser profile scanner so as to scan and/or evaluate the profile of the melt pool. Preferably, the monitored and/or evaluated state of the melt pool is used for controlling the at least one magnet by the first and/or second control means in order to adjust the melt pool support according to the state of the melt pool. This may maximize the effectiveness of the melt pool support as well as the quality of the additive manufactured part.

According to some embodiments, the magnetic pole pair may be arranged such, that it conducts substantially the same relative movement to the substrate and/or the build tray as the heat source and/or the material feed. The at least one magnet may be fixed to the heat source and/or the material feed.

According to embodiments, two magnetic pole pairs may be arranged within the building volume. A first magnetic pole pair may be oriented substantially horizontally perpendicular to a deposition direction. A second magnetic pole pair may be oriented substantially vertically perpendicular to the deposition direction. The first control means may be arranged to shift from the first magnetic pole pair to the second magnetic pole pair. Further, a third control means may be connected to the second magnetic pole pair so as to generate an oscillating magnetic field acting at least between the second magnetic pole pair. The first and the second magnetic pole pairs may generate an oscillating magnetic field at the same time. Further, in embodiments, the first and the second magnetic pole pair may be formed of three magnetic pole shoes including one magnetic pole shoe serving for both magnetic pole pairs.

In embodiments, three magnetic pole pairs may be arranged within the building volume so as to generate oscillating magnetic fields substantially vertically perpendicular to the deposition direction on the first side of the line and/or on the second side of the line and/or an oscillating magnetic field substantially horizontally perpendicular to the deposition direction. Three magnetic pole pairs may include at least four magnetic pole shoes.

Embodiments disclosed herein, may enable a contactless melt pool support such, that, for instance, one degree of freedom may be gained, enabling a higher freedom of design and therefore, reducing costs by more efficient designs. For example, overhangs with higher respectively lower angles to the build tray may be manufacturable. Further, the material output may be increased such that the DED-process may be accelerated.

Reference now will be made in detail to embodiments of the disclosure, some examples of which are illustrated in the drawings. Each example may be provided by way of explanation of the disclosure, not limitation of the disclosure. For instance, features illustrated or described as part of embodiments may be used with other embodiments to yield still further embodiments. The drawings may not be true-to-scale.

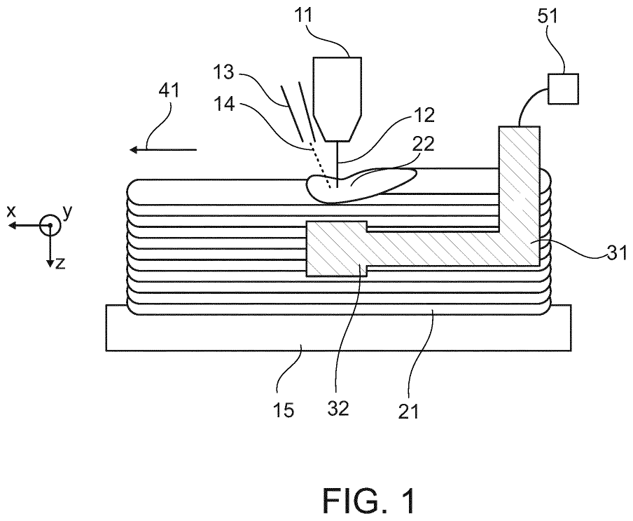

FIG. 1 is a side view on a schematic DED-process using an apparatus according to embodiments of this disclosure. FIG. 1 shows a heat source 11. The heat source 11 may be arranged for generating heat 12 by a focused laser beam, an electron beam, an arc, a light beam, a plasma or a like. The heat 12 may be directed to a focus point. Further, FIG. 1 shows a material feed 13 which may supply material 14 to a build tray 15 and/or to a substrate 21 line-by-line, layer-by-layer. The material feed 13 and the heat source 11 may be arranged in a common casing. In embodiments, the material feed 13 and the heat source 11 may be arranged in separate casings. The material 14 may be supplied by wire or by powder. The heat 12 may be directed to the material 14 such, that the material 14 may be deposited and melted substantially simultaneously, forming a melt pool 22. The melt pool 22 may extend on a length which center may not be at the focus point of the heat 12. Typically, the extension of the melt pool 22 may be of a larger dimension opposite to the deposition direction 41 than in the deposition direction 41.

According to embodiments illustrated in FIG. 1, the build tray 15 may be arranged parallel to the ground and moveable in a z-direction. The heat source 11 and the material feed 13 may be arranged on an x-axis and a y-axis so as to be arranged moveable in a plane.

In embodiments, the heat source 11, the build tray 15 and/or the material feed 13 may be arranged moveable and/or rotatable in/around the x-, y- and/or z-direction.

A magnet, e.g. embodied as an alternating current magnet, may be arranged in dependence of a position of the heat source 11 and/or of a position of the material feed 13. The alternating current magnet may comprise a magnetic core 31, including magnetic components, and a first 32 and a second magnetic pole shoe 33 arranged as a magnetic pole pair. The alternating current magnet may be connected to a first control means 51. The first control means 51 may be embodied as a function generator and/or an amplifier.

The material feed 13 may deposit material 14 in a deposition direction 41. Simultaneously, the heat source 11 may apply heat 12 to the material 14. The first control means 51 may apply an adjustable alternating current to the alternating current magnet by means of the frequency and amplitude.

According to embodiments, wherein a pulsed electron beam may be used for melting material 14, the first control means 51 may control the magnet such, that a magnetic field acts on the melt pool 22 only between two pulses of the electron beam.

According to the configuration shown in FIG. 1, the magnetic field may act horizontally perpendicular to the deposition direction. The center between the magnetic pole pair 32, 33 may be substantially at a level with the focus point of the heat 12. According to embodiments, the bottom edges of the magnetic pole pair 32, 33 may be arranged substantially on a level with the upper edge of the deposited material 14 so as a distance between the bottom edges of the magnetic pole pair 32, 33 and the upper edge of the deposited material 14 may be less than 2 mm, in particular less than 1 mm, preferably substantially 0 mm. In embodiments, the upper edges of the magnetic pole pair 32, 33 may be arranged substantially on a level with the upper edge of the deposited material 14.

The oscillating magnetic field may induce a current in the substrate 21, in particular in the melt pool 22. The resulting current may flow in the deposition direction 41. The resulting current is oriented to the oscillating magnetic field horizontally perpendicular so as a Lorentz force may counteract the gravitational force and/or a hydrostatic pressure.

According to embodiments, the material feed 13 may supply material 14 on the build tray 15 in a line in a deposition direction 41 being kinematically connected to the heat source 11 which may apply heat 12 simultaneously to the material 14. The magnet may be kinematically connected to the heat source 11 and/or the material feed 13, too, so as to support the melt pool 22 where material 14 is melted. The magnetic pole pair 32, 33 may be kinematically connected to the heat source 11 and/or the material feed 13 with an offset in the deposition direction 41, in order to support the melt pool 22 in its whole length as effective as possible.

The magnet may further be arranged moveable, for example, in order to adjust the position according to a state of the melt pool 22 which may be monitored and/or evaluated by a measuring device (not shown). The distance between the first magnetic pole shoe 32 to the substrate 21 may be the same or different to the distance of the second magnetic pole shoe 33 to the substrate 21. The distance between the magnetic pole pair 32, 33 may be adjustable.

The magnetic pole pair 32, 33 may be arranged tiltable, rotatable and/or retractable and extendable. For example, if a collision with the substrate 21 may threaten, a second control means may retract one or both magnetic pole shoes 32, 33. According to embodiments, the first control means 51 and/or a control means of the additive manufacturing system may act accordingly at a retraction and extension, a movement, a tilting and/or a rotation of at least one component of the magnet by means of, e.g. reducing the material 14 deposition.

According to some embodiments, the apparatus may shift from a first type of melt pool 22 support, e.g. a Lorentz force acting towards the z-direction, to a second type of melt pool 22 support, e.g. a Lorentz force acting laterally to the substrate 21 during the DED-process. The magnet may be configured switchable including a first magnetic pole pair arranged substantially horizontally perpendicular to the deposition direction 41 and a second magnetic pole pair arranged substantially vertically perpendicular to the deposition direction 41. According to some embodiments, two magnets may be connected to the first control means 51 such, that the first control means 51 may apply switchable an alternating current to either a first magnet or to a second magnet arranged perpendicular to the first magnet.

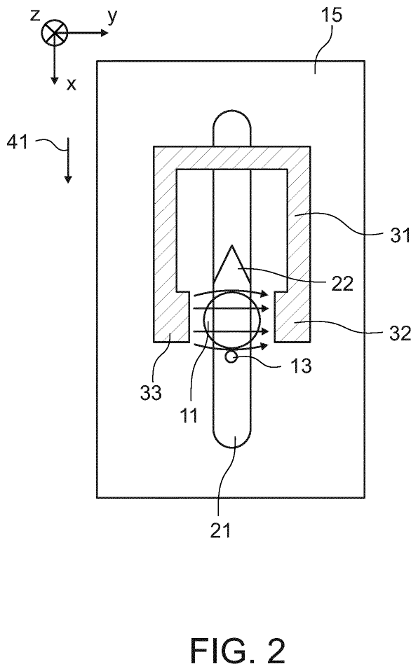

FIG. 2 is a top view on the schematic DED-process shown in FIG. 1. The distance in the y-direction between a first magnetic pole shoe 32 and a deposited material 14 may be substantially the same as the distance in the y-direction between a second magnetic pole shoe 33 and the deposited material 14. In particular, the distance between the magnetic pole shoe 32, 33 and the deposited material 14 in the y-direction is less than 10 mm, preferably the distance may be less than 5 mm. Particularly preferably, the distance may be less than 2 mm.

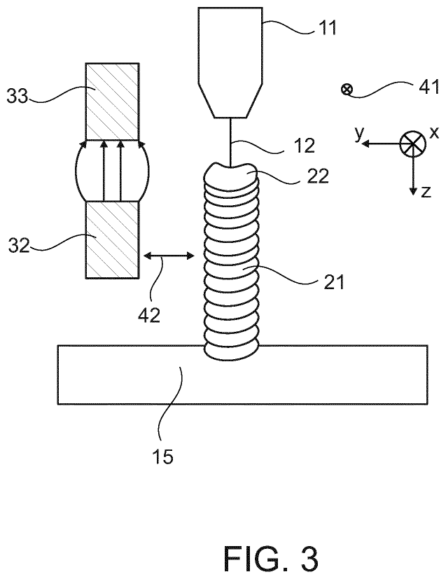

FIG. 3 is a front view on a DED-process using an apparatus according to embodiments of this disclosure. A material feed 13 may supply material 14 in a deposition direction 41 on a build tray 15 line-by-line, layer-by-layer. A heat source 11 may apply heat 12 to the material 14. A magnet may be connected to a first control means 51 and arranged such, that an oscillating magnetic field vertically perpendicular to the deposition direction 41 may act between a first magnetic pole shoe 32 and a second magnetic pole shoe 33. A current may be induced flowing in a direction opposite to the deposition direction 41. A Lorentz force may act laterally to the substrate 31 so as to support the melt pool 22.

The center of the magnetic pole pair 32, 33 may be arranged at a level of the melt pool 22. A distance 42 to the substrate 21 may be less than 20 mm. In particular, the distance 42 may be less than 8 mm. Particularly preferably, the distance 42 may be less than 5 mm.

The center of the magnetic pole pair 32, 33 may be in an x-direction at a level with the focus point of the heat 12. According to some embodiments, the magnetic pole pair 32, 22 may be at an offset to the focus point of the heat 12 in the x-direction. The magnet may move mutually with the heat source 11 and/or the material feed 13 so as to being kinematically connected to the heat source 11 and/or the material feed 13.

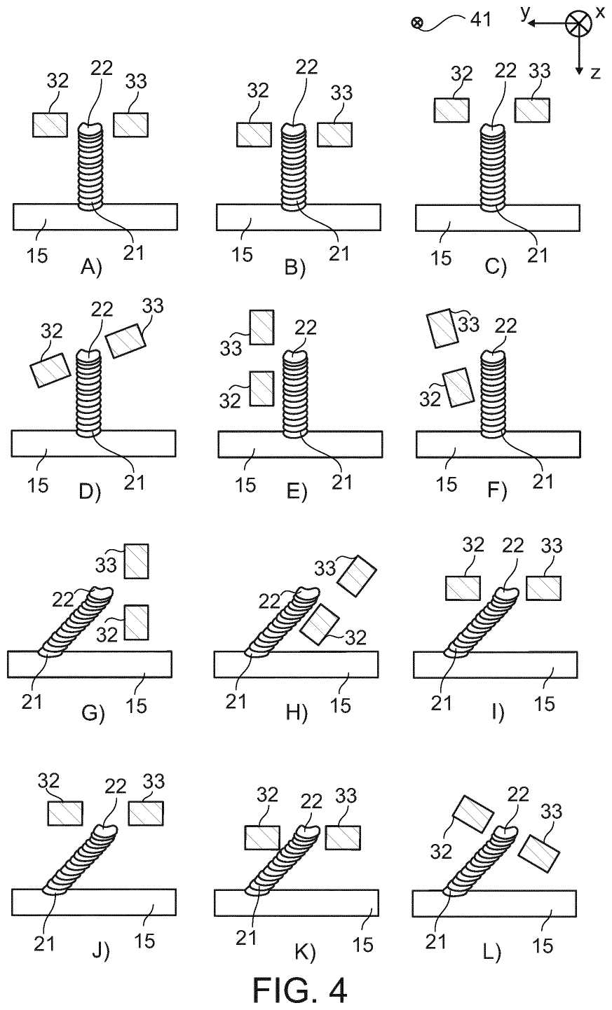

FIG. 4 shows schematically several arrangements of a magnetic pole pair 32, 33 according to embodiments of this disclosure in a front view. The gravitational force may act in the z-direction or at an angle to the z-direction. The coordinate system and the deposition direction 41 shown in FIG. 4 may mutually apply to all embodiments illustrated in FIG. 4 A through FIG. 4 I. FIG. 4 shows further in FIG. 4 A through FIG. 4 F a substrate 21 which may be build-up at an angle of 90° to the build tray 15. FIG. 4 G through FIG. 4 L illustrate a substrate 21 which may be build-up with an overhang angle.

A first 32 and a second magnetic pole shoe 33 may form a magnetic pole pair 32, 33. According to embodiments, the arrangement of the magnetic pole pair 32, 33 may be dependent of the angle between the z-direction and the direction of the gravitational force. In embodiments as illustrated in FIG. 4 A, the magnetic pole pair 32, 33 may be arranged at a level of the melt pool 22 horizontally perpendicular to a deposition direction 41. In embodiments according to FIG. 4 B, the magnetic pole pair 32, 33 may be arranged horizontally perpendicular to the deposition direction 41 and at a level such that the upper edge of the magnetic pole pair 32, 33 may substantially be aligned with the upper edge of the melt pool 22.

FIG. 4 C shows an arrangement of the magnetic pole pair 32, 33 wherein the lower edge of the magnetic pole pair 32, 33 may substantially be aligned with the upper edge of the melt pool 22. According to embodiments, the magnetic pole pair 32, 33 may be oriented angled to the z-direction as exemplarily illustrated in FIG. 4 D. The center of the magnetic pole pair 32, 33 may be arranged at a level of the melt pool 22. The magnetic pole pair 32, 33 may be arranged vertically perpendicular to the deposition direction 41 and the center may be arranged at a level of the melt pool 22 as shown in FIG. 4 E.

In embodiments, the magnetic pole pair 32, 33 may be arranged laterally to the substrate 21. According to embodiments illustrated in FIG. 4 F, the center of the magnetic pole pair 32, 33 may be arranged at a level of the melt pool 22 wherein the magnetic pole pair 32, 33 may be arranged laterally to the substrate at an angle to the z-direction.

In embodiments shown in FIG. 4 G through FIG. 4 L, the magnetic pole pair 32, 33 may be arranged in dependence of the overhang angle and/or in dependence of the angle between the z-direction and the direction of the gravitational force. The magnetic pole pair 32, 33 may be arranged laterally to the substrate 21 vertically perpendicular to the deposition direction 41 with the center of the magnetic pole pair 32, 33 at a level of the melt pool 22. The magnetic pole pair 32, 33 may be arranged laterally to the substrate 21 at an angle to the z-direction.

The magnetic pole pair 32, 33 may be arranged horizontally perpendicular to the deposition direction 41. As illustrated in FIG. 4 I, the center of the magnetic pole pair 32, 33 may be at a level of the melt pool 22. In embodiments, as illustrated in FIG. 4 J, the bottom edge of the magnetic pole pair 32, 33 may be aligned with the upper edge of the melt pool 22. As shown in FIG. 4 K, the upper edge of the magnetic pole pair 32, 33 may be aligned with the upper edge of the melt pool 22. In embodiments, the magnetic pole pair 32, 33 may be arranged angled to the z-direction. The distance between the magnetic pole pair 32, 33 may be adjustable.

Thus, an electromagnetic melt support for DED-processes has been presented in the foregoing description with reference to specific examples. It is to be understood that various aspects disclosed herein may be combined in different combinations than the specific combinations presented in the accompanying drawings. It is appreciated that various modifications to the referenced examples may be made without departing from the scope of the disclosure and the following claims.

1. An apparatus for generating external magnetic fields for supporting a melt pool, adapted for use in direct energy deposition based additive manufacturing processes, comprising:
a first control means, and
at least one magnet,
wherein the first control means is connected to the at least one magnet such that the magnet generates an oscillating magnetic field that is at least one of at the melt pool and inside the melt pool such that an eddy current is induced, and
wherein a resulting current is oriented to the oscillating magnetic field such that a Lorentz force acts on the melt pool.

2. The apparatus according to claim 1, wherein the magnetic field is oriented one of substantially horizontally perpendicular and vertically perpendicular to a deposition direction, and
wherein the resulting current is oriented substantially parallel to the deposition direction.

3. The apparatus according to claim 1, wherein the at least one magnet is configured for generating the magnetic field on a level of the melt pool.

4. The apparatus according to claim 1, wherein the at least one magnet is arranged such that a first magnetic pole is located on a first side of a line to be deposited and a second magnetic pole is located on one of the first side and a second side of the line to be deposited.

5. The apparatus according to claim 1, wherein at least one component of the at least one magnet is arranged to be at least one of rotatable, tiltable and moveable.

6. The apparatus according to claim 5, wherein the apparatus further comprises a second control means for at least one of rotating, tilting, moving and retracting and extending the at least one component of the at least one magnet.

7. The apparatus according to claim 1, wherein at least one of a strength, orientation and frequency of the magnetic field is at least one of variable, regulable, adjustable and controllable.

8. The apparatus according to claim 6, wherein the apparatus further comprises at least one measuring device for at least one of monitoring and evaluation of a state of the melt pool.

9. The apparatus according to claim 8, wherein at least one of the first control means and the second control means control with regard to the state of the melt pool.

10. The apparatus according to claim 1, wherein the magnetic field is switchable from an orientation substantially horizontally perpendicular to the deposition direction to an orientation substantially vertically perpendicular to the deposition direction.

11. An additive manufacturing system, comprising:
a heat source for applying heat on a material,
a material feed for supplying the material,
a build tray for receiving a substrate,
at least one control means for at least one of controlling and regulating an additive manufacturing process, and
an apparatus for generating external magnetic fields for supporting a melt pool and adapted for use in direct energy deposition based additive manufacturing processes, the apparatus comprising,
a first control means, and
at least one magnet,
wherein the first control means is connected to the at least one magnet such that the magnet generates a magnetic field that is at least one of at the melt pool and inside the melt pool such that an eddy current is induced, and
wherein a resulting current is oriented to the oscillating magnetic field such that a Lorentz force acts on the melt pool.

12. An additive manufacturing method based on direct energy deposition, comprising:
a) arranging a heat source for generating heat and a material feed for supplying a material on at least one of a substrate and a build tray such that the heat source is directed to the material;
b) arranging at least one magnet in dependence of at least one of a position of the heat source and a position of the material feed;
c) applying heat, supplied by the heat source, on the material, supplied by the material feed, such that at least the supplied material melts so as to form a melt pool;
d) controlling the magnet by a first control means such that an oscillating magnetic field acts substantially at the same time that is at least one of at the melt pool and inside the melt pool;
e) at least one of the heat source and the material feed conducting a relative movement to at least one of the substrate and the build tray such that the material is deposited, melted and solidified line-by-line, layer-by-layer;
wherein the oscillating magnetic field is configured for inducing an eddy current and wherein a resulting current is oriented to the oscillating magnetic field such that a Lorentz force acts on the melt pool.

13. The additive manufacturing method according to claim 12, wherein the magnetic field is oriented at least one of substantially horizontally perpendicular and vertically perpendicular to a deposition direction, and
wherein the resulting current is oriented substantially parallel to the deposition direction.

14. The additive manufacturing method according to claim 12, wherein a center between a first and a second magnetic pole of the at least one magnet is on a level of the melt pool.

15. The additive manufacturing method according to claim 12, wherein the at least one magnet is arranged such that a first magnetic pole is located on a first side of a line to be deposited and a second magnetic pole is located on one of the first side and a second side of the line to be deposited.

16. The additive manufacturing method according to claim 12, wherein at least one component of the at least one magnet is arranged to be at least one of rotatable, tiltable and moveable.

17. The additive manufacturing method according to claim 16, wherein the method further comprises arranging a second control means for at least one of rotating, tilting, moving and retracting and extending the at least one component of the at least one magnet.

18. The additive manufacturing method according to claim 12, wherein at least one of a strength, orientation and frequency of the magnetic field is at least one of variable, regulable, adjustable and controllable by the first control means.

19. The additive manufacturing method according to claim 12, wherein the method further comprises arranging at least one measuring device for at least one of monitoring and evaluation of a state of the melt pool.

20. The additive manufacturing method according to claim 19, wherein at least one of the first and the second control means control with regard to the state of the melt pool.

21. (canceled)

22. (canceled)
